(19) United States
(12) Patent Application Publication
(10) Pub. No.: US 2024/0074008 A1
(43) Pub. Date: Feb. 29, 2024

(54) BASE PLATE STRUCTURE FACILITATATING HEAT DISSIPATION OF HEATING COIL

(71) Applicant: PEACEWORLD CO., LTD, Gyeonggi-do (KR)

(72) Inventors: Myung Ock LEE, Gyeonggi-do (KR); Sang Woo KIM, Gyeonggi-do (KR)

(21) Appl. No.: 18/236,952

(22) Filed: Aug. 23, 2023

(30) Foreign Application Priority Data
Aug. 25, 2022 (KR) 10-2022-0106791

(51) Int. Cl. H05B 6/42; H05B 6/12

(52) U.S. Cl. CPC H05B 6/42; H05B 6/1209

(57) ABSTRACT

The present invention relates to a base plate structure facilitating heat discharge of a heating coil. According to some embodiment of the present invention, the base plate structure comprises a circular base plate where at least one or more hall effect sensors are disposed in a center sensor portion. One or more unit mounting groove portions are defined by a closed partition wall protruding from a lower side of the base plate. One or more protrusion portions protrude from an upper side of the base plate such that the heating coil wound in the upper side of the base plate is spaced apart from the upper side of the base plate. One or more heat discharge openings are provided in a bottom side of the unit mounting groove portions.

### CROSS-REFERENCE TO RELATED APPLICATION

The present application claims priority to Korean Patent Application No. 10-2022-0106791, filed on Aug. 25, 2022, the entire contents of which are incorporated herein by reference.

### BACKGROUND

### Technical Field

The present invention relates to a base plate structure used for an induction range. More specifically, the present invention relates to a base plate structure that facilitates heat dissipation of a heating coil such that heat is easily discharged from the heating coil which is utilized to increase transmittance of a magnetic field.

### Related Art

Recently, an induction range has been widely and increasingly used as a heating device for cooking food. As a cooking appliance that adopts a heating method of electromagnetic induction, the induction range is advantageous in many aspects, such as in high energy efficiency and stability. Also, the induction range provides a benefit in that the induction range barely consumes oxygen and does not emit waste gas. In such an induction range, lines of magnetic force produced when a high-frequency current is applied passes through a bottom of an induction cooking container laid on a top plate of the induction range, at which point an eddy current generated by a resistance component only heats the induction cooking container.

To this end, a heating coil in a form of a circular disk is used in the induction range. The heating coil is fixed on a top face of a base plate. Transmissivity of the magnetic field in the heating coil changes with the number of turns per unit area and the like. However, as for an under-induction range installed under a top plate of a table, the distance between the base plate and the induction cooking container increases compared to a general induction range. Accordingly, the under-induction range requires higher transmission of the magnetic field. Consequently, heating coils where two or more layers of heating coils are stacked are used. Moreover, a ferrite core is additionally used at a lower side of the base plate to increase the magnetic field.

In a conventional under-induction range, the use of heating coils having two or more layers stacked may cause an accident, such as fire, due to increase in heat generation. Additionally, when the ferrite core is continuously exposed to heat, it may break due to a crack. This relates to quality of the under-induction range, which damages a brand image of its manufacturing company and raises aftersales costs.

### SUMMARY

Embodiments of the present invention have been made in an effort to solve the above-mentioned problems. An objective of the present disclosure is to provide a base plate structure that may facilitate heat dissipation of a heating coil having at least two or more stacked layers of coils.

More specifically, an objective of the present disclosure is to provide a structure that may more effectively air-cool a heating coil with enhanced transmission of the magnetic field.

In addition, an objective of the present disclosure is to provide a structure that may prevent cracked damage of a ferrite core, resulting from exposure to heat. Moreover, an objective of the present disclosure is to present a structure that may effectively cool a region where heat is concentrated in a heating coil.

Based on the above, an objective of the present disclosure is to provide a base plate structure which can resolve quality issues, such as malfunctioning and accidents induced by heat of a heating coil.

To resolve the above-mentioned tasks, according to the present disclosure, a base plate structure is provided.

According to the present invention, a base plate structure facilitating heat discharge of a heating coil comprises a circular base plate, wherein at least one or more hall effect sensors are disposed in a center sensor portion; one or more unit mounting groove portions, each of which is defined by a closed partition wall protruding from a lower side of the base plate, wherein the unit mounting groove portions are repeatedly disposed as an annulus with respect to the center sensor portion and a ferrite core is coupled to the unit mounting groove portions; one or more protrusion portions protruding from an upper side of the base plate such that the heating coil wound in the upper side of the base plate is spaced apart from the upper side of the base plate; and
one or more heat discharge openings provided in a bottom side of the unit mounting groove portions.

In an embodiment, the base plate structure further comprises one or more heating coil coupling portions, each of which is provided between the unit mounting groove portions adjacent to each other, wherein the heating coil coupling portions are repeatedly disposed in a radial direction with respect to the center sensor portion so that the heating coil is fixed in the upper side of the base plate.

In an embodiment, the heat discharge openings are repeatedly disposed as an annulus with respect to the center sensor portion and cause an upper space of the base plate and a lower space of the base plate to vertically communicate with each other.

In an embodiment, each of the protrusion portion includes a pair of main protrusion portions traversing between the heat discharge openings adjacent to each other and extending from the center sensor portion to a periphery portion of the base plate in a radial direction; and a sub-protrusion portion disposed between the pair of the main protrusion portions and extending from a point spaced from each heat discharge opening to the periphery portion in the radial direction.

In an embodiment, each of the protrusion portions has a preset width and a preset height and is a straight-line type which extends in a radial direction, wherein a width of the sub-protrusion is larger than a width of the main protrusion portions.

In an embodiment, a plurality of circular holes having a predetermined radius are disposed in a center of the center sensor portion such the hall effect sensors pass therethrough in a vertical direction and fixed therein, wherein the circular holes are arranged in one direction and adjacent circular holes of the plurality of circular holes are partially overlapped with each other.

In an embodiment, at least one or more cooling fans are disposed in the lower side of the base plate, wherein, when the heating coil is coupled to the upper side of the base plate, an upward wind generated by the cooling fans and ascending therefrom passes through the heat discharge openings, and then the upward wind is guided in the radial direction of the base plate along a flow path formed by the heating coil and the protrusion portions to be discharged outside the base plate.

In an embodiment, the ferrite core is coupled to the bottom side of the unit mounting groove portions.

According to the above-described features of the present invention, various effects including the following may be expected. However, the present invention can function without providing all the effects described below.

A base plate structure according to an embodiment of the present disclosure may facilitate heat dissipation of a heating coil having at least two or more stacked layers of coils. More specifically, a structure according to an embodiment of the present disclosure may more effectively air-cool a heating coil with enhanced transmission of the magnetic field.

In addition, provided is a structure that may prevent cracked damage of a ferrite core, resulting from exposure to heat. Moreover, provided is a structure that may effectively cool a region where heat is concentrated in a heating coil.

Based on the above, provided is a base plate structure which can resolve quality issues, such as malfunctioning and accidents induced by heat of a heating coil.

### BRIEF DESCRIPTION OF THE DRAWINGS

FIG. 1 is a perspective view of a base plate structure facilitating heat dissipation of a heating coil according to an embodiment of the present invention.

FIG. 2 is a plan view of FIG. 1.

FIG. 3 is a perspective view, viewed from a different direction than FIG. 1.

FIGS. 4A and 4B show a heating coil coupled to a top side of a base plate of FIG. 1.

FIG. 5 depicts a view of a heating coil of FIGS. 4A and 4B, discharging heat by an upward wind.

FIG. 6 depicts a ferrite core coupled to a lower side of a base plate of FIGS. 4A and 4B.

### DETAILED DESCRIPTION

Example embodiments of the present disclosure are described with reference to the appended drawings to enable a sufficient understanding about elements and effects of the present disclosure. However, the present disclosure is not limited to the disclosed embodiments below. Various forms may be obtained, and various modifications can be applied. Below, in describing the present invention, explanation on related known functions may be omitted if it is determined that the known functions are well-known to one having ordinary skill in the art and may obscure essence of the present invention.

Terms, such as “first,” “second,” etc., may be used herein to describe various elements. However, the elements should not be understood as being limited by these terms. These terms may be only used in distinguishing one element from another. For example, a first element may be referred to as a second element, and, similarly, a second element may be referred to as a first element, within the scope of the present disclosure.

Herein, terms, such as “comprise,” “include,” “have,” etc., are designed to indicate features, numbers, steps, operations, elements, components, or a combination thereof are present. It should be understood that presence of one or more other features, numbers, steps, operations, elements, components, or a combination thereof or a possibility of addition thereof are not excluded.

Terms used herein are only to explain certain embodiments but not to limit the present invention. A singular representation may include a plural representation unless a clearly different meaning can be grasped from the context. Unless defined differently, terms used in embodiments of the present disclosure may be interpreted as generally known terms to one having ordinary skill in the art.

Example embodiments of the present invention are described in detail with reference to the appended drawings.

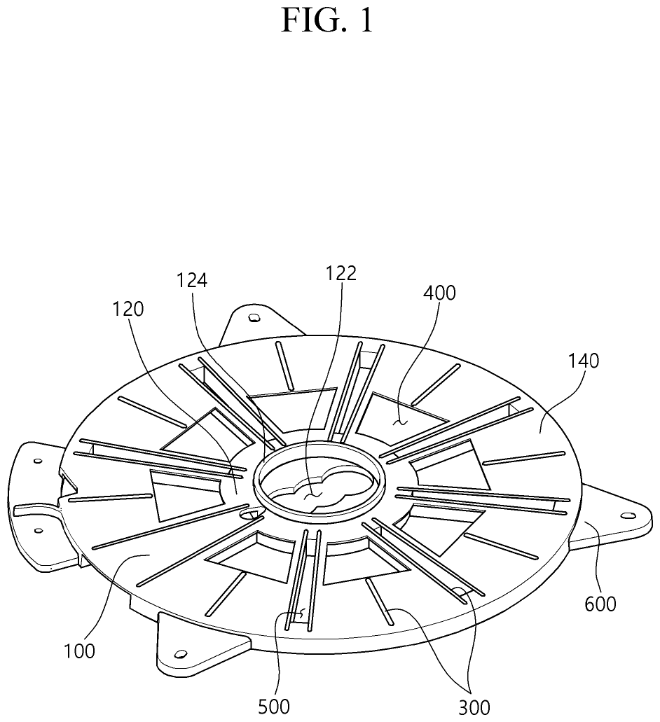

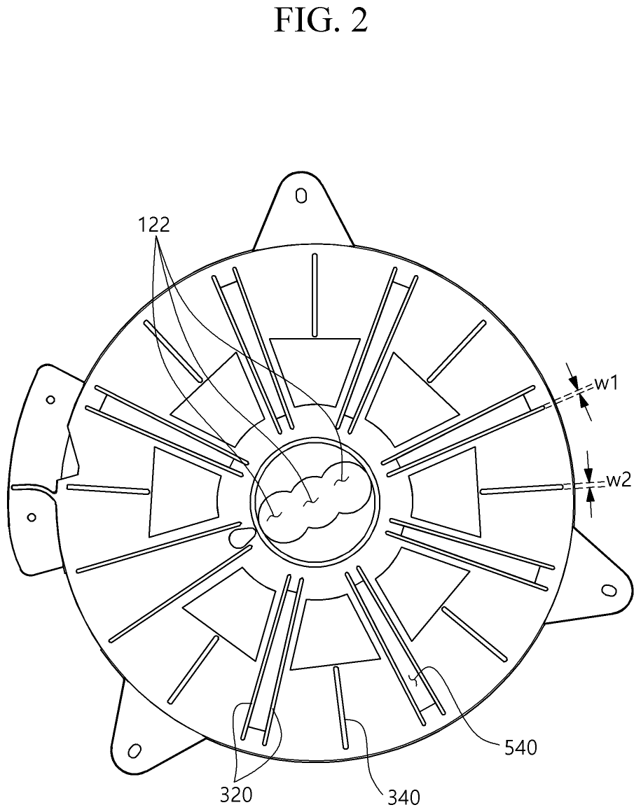

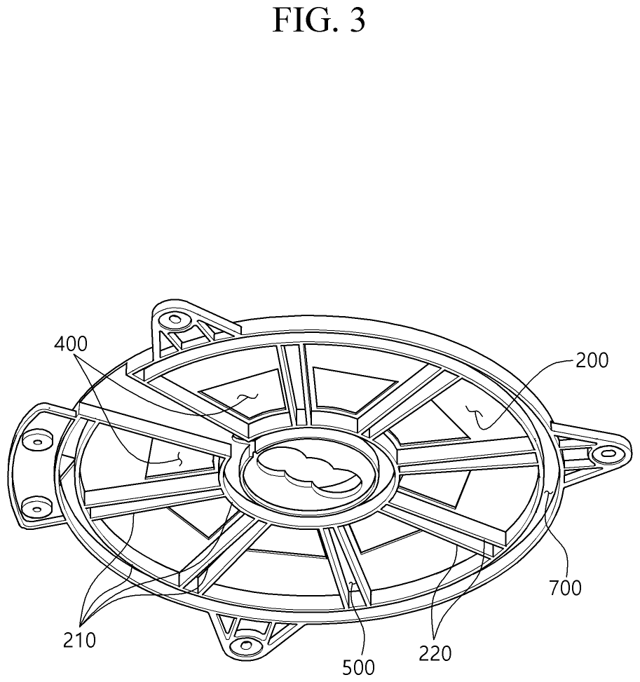

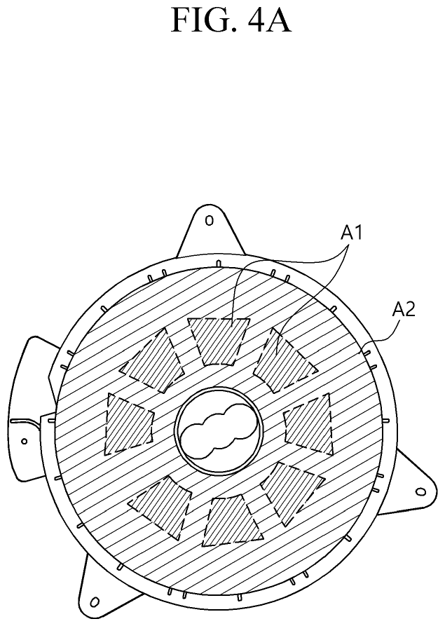

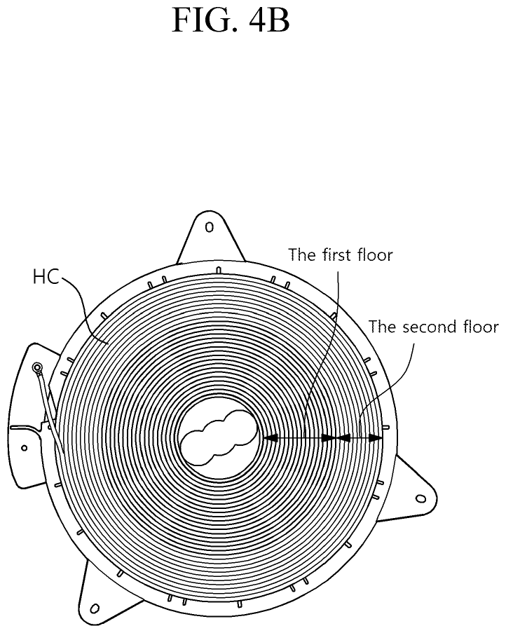

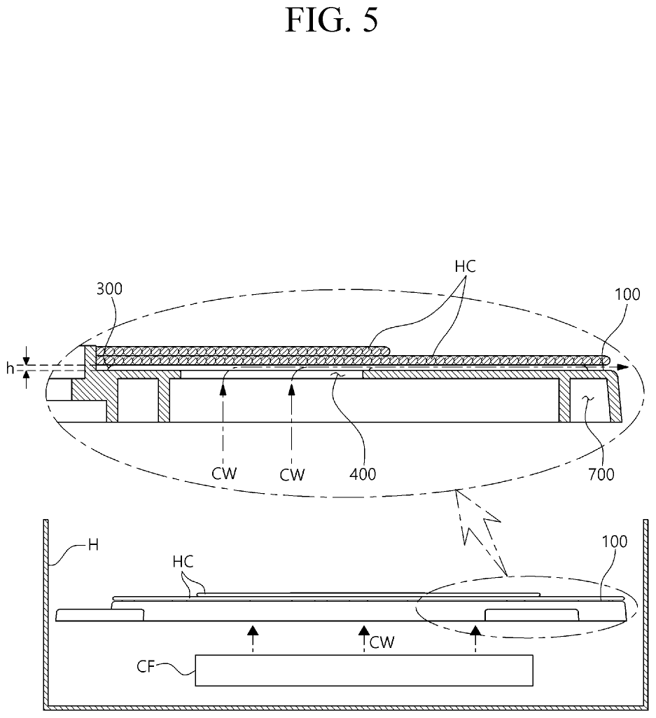

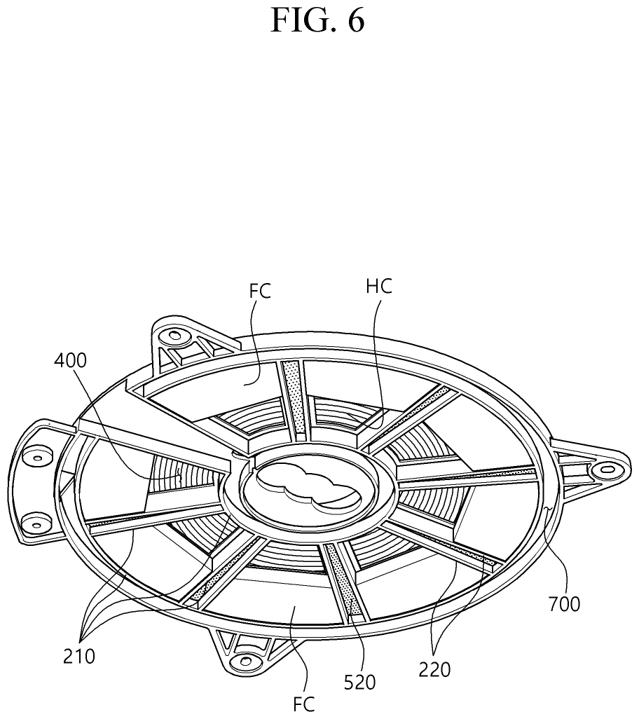

FIG. 1 is a perspective view of a base plate structure facilitating heat dissipation of a heating coil according to an embodiment of the present invention, FIG. 2 is a plan view of FIG. 1, and FIG. 3 is a perspective view, viewed from a different direction than FIG. 1. FIGS. 4A and 4B show a heating coil coupled to a top side of a base plate of FIG. 1, FIG. 5 depicts a view of a heating coil of FIGS. 4A and 4B, discharging heat by an upward wind, and FIG. 6 depicts a ferrite core FC coupled to a lower side of a base plate of FIGS. 4A and 4B.

Referring to FIGS. 1 to 6, a base plate structure facilitating heat dissipation of a heating coil according to an embodiment of the present invention may comprise a base plate 100, a unit mounting groove portion 200, a protrusion portion 300, a heat dissipation opening 400, a heating coil coupling portion 500, a cooling fan CF, and the like.

The base plate 100 has a shape of a circular flat plate. The base plate 100 includes a center sensor portion 120. At least one or more hall effect sensors (not show) are disposed in the center sensor portion 120. In an embodiment, a circular hole 122 having a predetermined radius is formed at a center of the center sensor portion 120 such that a part of the hall effect sensor is inserted in a vertical direction. In an embodiment, one or more circular holes 12 may be formed. The circular holes 122 are arranged in one direction, and adjoining circular holes may have a portion overlapped with each other. Therefore, the manufacturer may change a position of the hall effect sensor in consideration of the number of hall effect sensors, a design object of an induction range, and the like.

The hall effect sensor detects a small voltage which is generated when the hall effect sensor reacts with the magnetic field. The hall effect sensor functions as a sensor by amplifying the small voltage by a transistor. Such a hall effect sensor may be preferably disposed at a center of a heating coil HC. In an embodiment, the hall effect sensor and the heating coil HC may be preferably positioned at a same height within a housing H of an induction range. Also, the hall effect sensor according to an embodiment may be a contactless-type, thereby being semi-permanently usable. Additionally, the hall effect sensor may be connected to a printed circuit board through a wire, etc.

A coil separation prevention portion 124 is provided. The coil separation prevention portion 124 surrounding the circular hole 122 is provided in an upper side of the center sensor portion 120. The coil separation prevention portion 124 protrudes upward to have a circular, partition-wall shape. The center of the heating coil HC coupled to an upper side of the base plate 100 is fitted into the coil separation prevention portion 124, thereby preventing the heating coil HC from separating.

In addition, a coupling bracket portion 600 may be disposed in an outer periphery 140 of the base plate 100. The coupling bracket portion 600 allows the base plate 100 to be fixedly disposed in an inner space of the housing H of the induction range. In an embodiment, the coupling bracket portion 600 may have at least one or more coupling holes. As a result, the base plate 100 may be firmly fixed in the housing H through a fastening member (not shown), such as a bolt. Furthermore, one or more coil fixing portions where both ends of the heating coil HC is fixed may be formed in the outer periphery 140 of the base plate 100. Also, a periphery groove portion 700 may be formed in a lower side of the base plate 100 at a radially outermost portion with respect to the center sensor portion 120.

The unit mounting groove portion 200 is defined by a closed partition wall 210 which protrudes in the lower side of the base plate. A plurality of unit mounting groove portions 200 may be repeatedly disposed with respect to the center sensor portion 120 in an annular manner. In other words, the unit mounting groove portions 200 are formed in the lower side of the base plate 100. The unit mounting groove portion 200 may be formed radially from the center sensor portion 120. The unit mounting groove portion 200 resembles a fan shape.

In addition, the ferrite core FC may be coupled to a bottom side of the unit mounting groove portion 200. As a result, the ferrite core FC may be stably accommodated within the unit mounting groove portion 200. The ferrite core FC may function to increase a magnitude of the magnetic field that is generated in the heating coil HC. Moreover, the ferrite core FC prevents leakage of the magnetic force in a downward direction, which is transferred from the heating coil HC. In an embodiment, the ferrite core FC may be mounted to the unit mounting groove portion 200 through a separate boding process. In an embodiment, the position of the bottom side of the unit mounting groove portion 200 is limited to an outer part due to the heat dissipation opening 400 arranged adjacent to the center sensor portion 120.

According to an embodiment, the heating coil coupling portion 500 may be arranged between the unit mounting groove portions 200 adjacent to each other. The heating coil coupling portion 500 may have a plurality of heating coil coupling portions 500. Each of the heating coil coupling portions 500 is repeatedly arranged in a radial direction with respect to the center sensor portion 120 such that the heating coil HC is fixed in the upper side of the base plate 100. The heating coil HC may be stably coupled to the upper side of the base plate 100 by the coil separation prevention portion 124 and the heating coil coupling portion 500.

According to an embodiment, the heating coil coupling portion 500 may comprise a receiving space portion 520, a bonding opening 540, and the like. The receiving space portion 520 may include a radial partition wall 220 (out of the closed partition walls 210 that define the unit mounting groove portions 200) disposed radially with respect to the center sensor portion 120. In other words, the receiving space portion 520 may be formed at the lower side of the base plate 100. An adhesive AH or the like may be placed into the receiving space portion 520 to have a predetermined thickness. In an embodiment, silicon having a predetermined range of viscosity may be used as the adhesive AH. In an embodiment, it is preferable that silicon does not easily flow.

In an embodiment, the bonding opening 540 is defined by a bottom side of the receiving space portion 520 being entirely opened. The bonding opening 540 may cause an upper space of the base plate 100 and a lower space of the base plate 100 to communicate with each other. When the heating coil HC is disposed on an upper side of the base plate 100, the adhesive AH inserted into the receiving space portion 520 passes through the boding opening 540 and then is applied to a lower side of the heating coil HC. The adhesive AH may be applied to the lower side of the heating coil HC to have a shape that corresponds to a shape of the bonding opening 540.

It is necessary to maximize a heating efficiency with respect to a container to be heated by increasing the number of turns per unit area of the heating coil HC. To this end, the heating coil HC is wound a plurality of times and adapted to have at least one or more stacks (layers). As a result, heat generated in the heating coil HC may increase. This may be a cause of the cracked damage of the ferrite core FC accommodated in the unit mounting groove portion 200 due to heat deformation. Also, this causes malfunctioning of the induction range, resulted from overheat of the heating coil HC.

An empty space is formed in the center of the heating coil HC. In an embodiment, the heating coil HC is stacked in two layers, but only a part of the coil is wound in the second layer. The empty space in the center of the heating coil HC is fitted into the coil separation prevention portion 124, and the lower side thereof may be stably secured to the upper side of the base plate 100 by being bonded by the adhesive AH applied thereto.

The heat dissipation opening 400 is formed in the bottom side of the unit mounting groove portion 200. The heat dissipation opening 400 may be preferably formed for each unit mounting groove portion 200. In an embodiment, the area of the bottom side of the unit mounting groove portion 200 may be reduced because of the heat dissipation opening 400, which means the size of the ferrite core FC is reduced by the corresponding amount. If the size of the heat dissipation opening 400 is increased, heat discharge of the heating coil HC may be facilitated.

The heat dissipation opening 400 is disposed adjacent to the center sensor portion 120. The heat dissipation opening 400 is formed in the radial direction with respect to the center sensor portion 120. In addition, the heat dissipation opening 400 is repeatedly disposed like as an annulus with respect to the center sensor portion 120. The size, shape and the like of the heat dissipation opening 400 may be varied depending on the heating coil HC.

In an embodiment, as the size of the heat dissipation opening 400 increases, the size of the bottom side of the unit mounting groove portion 200 decreases. In other words, as the effect of heat dissipation of the heating coil HC improves, the effect of increasing the magnetic field of the heating coil HC by the ferrite core FC relatively decreases.

The heat dissipation opening 400 causes the upper space of the base plate 100 and the lower space of the base plate 100 to communicate with each other in the vertical direction. The heat dissipation opening 400 enables an upward wind CW generated by the cooling fan CF in the lower space of the base plate 100 to contact with the heating coil HC. As a result, a temperature of a contact surface of the heating coil HC directly exposed to the upward wind CW decreases, whereby heat can be discharged.

The protrusion portion 300 allows the wound heating coil HC coupled to the upper side of the base plate 100 to be spaced from the upper side of the base plate 100. In other words, the heating coil HC is positioned at a predetermined height h from the upper side of the base plate 100. As a result, the protruding portion 300 may provide a flow path between the heating coil HC and the upper side of the base plate 100.

The protrusion portion 300 has a shape of protruding from the upper side of the base plate 100. The protrusion portion 300 may be a shape of any one of a point, a straight line, a curved line, and a surface or a combination of two or more thereof. In an embodiment, the protrusion portion 300 may have a preset width and a preset height and may be a straight-line type radially extending. The height of the protruding portion 300 may be shaped such that the height gradually increases while extending in the radial direction.

In an embodiment, the protrusion portion 300 may include one or more main protrusion portions 320 and one or more sub-protrusion portions 340. The main protrusion portion 320 and the sub-protrusion portion 340 may be straight-line typed. The main protrusion portion 320 may be provided as a pair. The main protrusion portion 320 traverses between the heat discharge openings 400 adjacent to each other. In addition, the main protrusion portion 320 extends in the radial direction from the center sensor portion 120 to the periphery portion 140 of the base plate 100. Moreover, the bonding opening 540 may be disposed between the pair of the main protrusion portions 320. Here, each of the main protrusion portions 320 may extend along opposing edges of the bonding opening 540.

Each sub-protrusion portion 340 is disposed between the main protrusion portions 320. In an embodiment, the sub-protrusion portion 320 is disposed between the main protrusion portions 320 adjacent to each other. To be illustrated, the sub-protrusion portion 340 may extend in the radial direction from a point spaced from the heat discharge opening 400 to the periphery portion 140. In an embodiment, a width w2 of the sub-protrusion portion 340 may be larger than a width w1 of the main protrusion portion 320.

The base plate structure according to an embodiment may further comprise the cooling fan CF. The cooling fan CF may be driven by an electric motor and the like and force air toward a subject. In an embodiment, the cooling fan CF is positioned within the housing H of the induction range. In an embodiment, at least one or more cooling fans CF are disposed in the lower side of the base plate 100. The cooling fan CF is disposed in such a way to send the air vertically upward.

In an embodiment, when the heating coil HC is coupled to the upper side of the base plate 100, the upward wind CW generated by the cooling fan CF and ascending therefrom passes through the heat discharge opening 400. Then the upward wind CW is guided in the radial direction along the flow path formed by the heating coil HC and the protrusion portion 300 and discharged outside the base plate 100.

In other words, the upward wind CW passes through the heat discharge opening 400 and vertically encounters the lower side of the heating coil HC. Here, a first heat discharge region A1 positioned vertically above the heat discharge opening 400 and a second heat discharge region A2 may be formed in the heating coil HC. In the first heat discharge region A1, the upward wind CW with an increased speed as passing through the heat discharge opening 400 collides with the heating coil HC, whereby heat is intensively discharged. In the second heat discharge region A2, the upward wind CW moves in the radial direction of the base plate 100, which causes the heat to be gradually discharged. The second heat discharge region A2 means a region in the heating coil HC, excluding the first heat discharge region A1.

Preferred embodiments of the present invention are explained as an example above, but the scope of the present invention is not limited to those described embodiments. Modifications can be made within the scope of the claims.

What is claimed is:

1. A base plate structure facilitating heat discharge of a heating coil, comprising:
a circular base plate, wherein at least one or more hall effect sensors are disposed in a center sensor portion;
one or more unit mounting groove portions, each of which is defined by a closed partition wall protruding from a lower side of the base plate, wherein the unit mounting groove portions are repeatedly disposed as an annulus with respect to the center sensor portion and a ferrite core is coupled to the unit mounting groove portions;
one or more protrusion portions protruding from an upper side of the base plate such that the heating coil wound in the upper side of the base plate is spaced apart from the upper side of the base plate; and
one or more heat discharge openings provided in a bottom side of the unit mounting groove portions.

2. The base plate structure of claim 1, further comprising one or more heating coil coupling portions, each of which is provided between the unit mounting groove portions adjacent to each other, wherein the heating coil coupling portions are repeatedly disposed in a radial direction with respect to the center sensor portion so that the heating coil is fixed in the upper side of the base plate.

3. The base plate structure of claim 1, wherein the heat discharge openings are repeatedly disposed as an annulus with respect to the center sensor portion and cause an upper space of the base plate and a lower space of the base plate to vertically communicate with each other.

4. The base plate structure of claim 1, wherein each of the protrusion portions includes:
a pair of main protrusion portions traversing between the heat discharge openings adjacent to each other and extending from the center sensor portion to a periphery portion of the base plate in a radial direction; and
a sub-protrusion portion disposed between the pair of the main protrusion portions and extending from a point spaced from each heat discharge opening to the periphery portion in the radial direction.

5. The base plate structure of claim 4, wherein each of the protrusion portions has a preset width and a preset height and is a straight-line type which extends in the radial direction, wherein a width of the sub-protrusion is larger than a width of the main protrusion portions.

6. The base plate structure of claim 1, wherein a plurality of circular holes having a predetermined radius are disposed in a center of the center sensor portion such the hall effect sensors pass therethrough in a vertical direction and fixed therein, wherein the circular holes are arranged in one direction and adjacent circular holes of the plurality of circular holes are partially overlapped with each other.

7. The base plate structure of claim 1, further comprising at least one or more cooling fans disposed in the lower side of the base plate, wherein, when the heating coil is coupled to the upper side of the base plate, an upward wind generated by the cooling fans and ascending therefrom passes through the heat discharge openings, and then the upward wind is guided in a radial direction of the base plate along a flow path formed by the heating coil and the protrusion portions to be discharged outside the base plate.

8. The base plate structure of claim 1, wherein the ferrite core is coupled to the bottom side of the unit mounting groove portions.
